(19) United States
(12) Patent Application Publication
(10) Pub. No.: US 2026/0239387 A1
(43) Pub. Date: Aug. 13, 2026

(54) METHOD AND DEVICE FOR DETERMINING RESOURCES FOR SIDELINK TRANSMISSION

(71) Applicant: Samsung Electronics Co., Ltd., Suwon-si, Gyeonggi-do (KR)

(72) Inventors: Miao ZHOU, Beijing (CN); Feifei SUN, Beijing (CN); Pengru LI, Beijing (CN)

(21) Appl. No.: 19/156,595

(22) PCT Filed: Feb. 15, 2024
(86) PCT No.: PCT/KR2024/095162

§ 371 Date: Aug. 14, 2025

(30) Foreign Application Priority Data
Feb. 15, 2023 (CN) 202310126127.7
May 12, 2023 (CN) 202310539592.3

(51) Int. Cl. H04W 72/25; H04L 1/1867

(52) U.S. Cl. CPC H04W 72/25; H04L 1/1896

(57) ABSTRACT

The disclosure relates to a 5G or 6G communication system for supporting a higher data transmission rate. The disclosure provides a method performed by a first node in a communication system and a node device for performing the method, wherein the method comprises: determining resources for transmitting sidelink transmissions; and transmitting the sidelink transmissions on the determined resources, wherein if the determined resources include multiple consecutive time units and N time units of the multiple consecutive time units unavailable for the sidelink transmissions, at least one of the sidelink transmissions is transmitted on a time unit available for the sidelink transmissions, and/or at least one of the sidelink transmissions is transmitted on a time unit other than the multiple consecutive time units and consecutive with the time unit available for the sidelink transmissions of the multiple consecutive time units; and/or the determined resources are determined among resources whose number is greater than the number of resources required for the sidelink transmission; and/or the determined resources are the candidate resources satisfying a first condition in a first candidate resources set.

### TECHNICAL FIELD

The present application relates to the technical field of wireless communication, and in particular to a method for sidelink (SL) communication based positioning and a device thereof in a wireless communication system, for example, a wireless communication system in the fifth generation new radio access technology (5G NR) system.

### BACKGROUND ART

In the Long Term Evolution (LTE) technology, sidelink communication includes two main mechanisms, which are Device to Device (D2D) direct communication and Vehicle to everything (Vehicle to Vehicle/Infrastructure/Pedestrian/Network, V2X), among which V2X is designed on the basis of D2D technology, which is superior to D2D in data rate, delay, reliability and link capacity, and is the most representative sidelink communication technology in LTE technology.

As the evolution technology of LTE, the 5G NR system also includes the further evolution of sidelink communication. As the evolution version of LTE V2X technology, NR V2X technology is formulated in version 16, and its performance in all aspects is superior. In Release 17, the 5G NR system is expected to further extend the application scenarios of NR V2X to other wider application scenarios, such as commercial sidelink communication and Public Safety (PS) scenarios. In Release 18, 5G NR SL will further introduce the evolution corresponding to other scenarios and applications, such as SL technology in high frequency (FR2), unlicensed frequency band, and SL technology corresponding to specific applications such as positioning.

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The present disclosure may provide a method for SL communication based positioning and a device thereof in a wireless communication system.

In the sidelink communication system of LTE and NR, the sidelink communication system is designed mainly based on the requirements of specific D2D and vehicle business scenarios, and the frequency bands used by the system are mainly concentrated on specific licensed frequency bands, such as ITS frequency bands dedicated for vehicle traffic. With the development of 5G technology, the business modes for sidelink communication are growing, so it is necessary to enhance the sidelink communication technology so that it can be applied to a wider range of application scenarios, such as XR, IIoT, RedCap and so on. For the business requirements of some future application scenarios, the transmission rate, latency and reliability achieved by the current sidelink communication technology are needed to be further enhanced. A feasible method is to apply the sidelink communication to more frequency bands, such as unlicensed frequency bands, to increase the transmission rate and improve reliability supported by the sidelink system by increasing bandwidth, and reduce the service transmission latency through high-frequency communication. However, the current sidelink communication system has not discussed the possibility of sidelink communication in the unlicensed frequency bands, and has not introduced any enhancement mechanism for the unlicensed frequency bands.

In the sidelink communication system for data transmission, the criteria for determining the sidelink resources are determined based on reducing interference, but whether it is necessary to introduce new criteria for determining the sidelink resources based on traffic characteristics in the sidelink communication system for positioning and the sidelink communication system where data and positioning coexist is not considered.

The present disclosure provides a method for sidelink UE to select resources on multiple consecutive time units (for example, multiple consecutive slots) in an unlicensed frequency band, and/or for multiple consecutive time transmission situations, for example, a processing method when LBT fails. By this method, multiple consecutive slots with better performance can be selected to resist the risk of potential failure of LBT in the unlicensed frequency bands, and the selected consecutive slots can be flexibly used.

The present disclosure also provides a method for enhancing the sidelink resource determination process in case that the sidelink communication system is used for positioning or positioning and communication. By implementing this method, the resources utilization rate of the resources pool can be effectively improved and the fragmentation degree of the resources in the resources pool can be reduced.

The technical objects to be achieved by various embodiments of the disclosure are not limited to the technical objects mentioned above, and other technical objects not mentioned may be considered by those skilled in the art from various embodiments of the disclosure to be described below.

### Solution to Problem

According to some embodiments of the present disclosure, a method performed by a first node in a communication system is provided, the method comprises: determining resources for transmitting sidelink transmissions; and transmitting the sidelink transmissions on the determined resources, wherein if the determined resources include multiple consecutive time units and N time units of the multiple consecutive time units unavailable for the sidelink transmissions, at least one of the sidelink transmissions is transmitted on time units available for the sidelink transmissions of the multiple consecutive time units, and/or at least one of the sidelink transmissions is transmitted on time units other than the multiple consecutive time units and consecutive with the time units available for the sidelink transmissions of the multiple consecutive time units, wherein N is an integer greater than or equal to 1; and/or the determined resources are determined among resources whose number is greater than the number of resources required for the sidelink transmission; and/or the determined resources are the candidate resources satisfying a first condition in a first candidate resources set, and the first condition includes that the candidate resources include multiple consecutive time units and each time unit does not include physical sidelink feedback channel (PSFCH) resource.

In some embodiments, the method further comprises transmitting an indication that the sidelink transmissions are on multiple consecutive time units.

In some embodiments, in the case that N time units of the multiple consecutive time units are unavailable for the sidelink transmissions, transmitting the sidelink transmissions on the determined resources comprises at least one of: adjusting priorities of the sidelink transmissions and transmitting at least one of the sidelink transmissions based on the adjusted priorities; delaying time units occupied by the sidelink transmissions, and transmitting at least one of the sidelink transmissions based on the time units available for the sidelink transmissions and/or the delayed time unit of the multiple consecutive time units; determining that at least one of the sidelink transmissions is dropped and/or determining that at least one of the sidelink transmissions is transmitted; and reselecting resources for at least one of the sidelink transmissions.

In some implementations, adjusting the priorities of the sidelink transmissions comprises at least one of: setting the priority of at least one of the sidelink transmissions as the priority configured by the high layer plus an offset, wherein the offset is configured and/or preset; setting the priority of at least one of the sidelink transmissions as the highest priority of the sidelink transmissions; adjusting the priorities of sidelink transmissions on each time unit of the multiple consecutive time units; and adjusting the priorities of the sidelink transmissions on the delayed time units, and/or the priorities of the transmissions on the time units available for the sidelink transmissions of the multiple consecutive time units.

In some implementations, N time units of the multiple consecutive time units are unavailable for the sidelink transmissions, including at least one of: the first node fails to occupy the channel on the first N time units or any N time units of the multiple consecutive time units; and the first N time units or any N time units of the multiple consecutive time units are reserved by other nodes.

In some implementations, delaying the time units occupied by the sidelink transmissions comprises: if there are resources available for at least one sidelink transmission on the delayed N time units and if the delayed N time units and the time units available for the sidelink transmissions are consecutive in the time domain, delaying the time units occupied by the sidelink transmissions.

In some implementations, the method further comprises: transmitting one or more sidelink transmissions with larger remaining packet delay budgets (PDBs) among the sidelink transmissions and/or transmitting one or more sidelink transmissions with later time point corresponding to the remaining PDBs among the sidelink transmissions on the delayed N time units.

In some implementations, the method further comprises: transmitting one or more sidelink transmissions with low priorities among the sidelink transmissions on the delayed N time units, and/or transmitting one or more sidelink transmissions with high priorities among the sidelink transmissions on non-delayed time units.

In some implementations, determining that at least one of the sidelink transmissions is dropped and/or determining that at least one of the sidelink transmissions is transmitted comprises at least one of: if the resources corresponding to a first sidelink transmission among the sidelink transmissions are unavailable for the sidelink transmissions, the first sidelink transmission is dropped, and/or if the resources corresponding to a second sidelink transmission among the sidelink transmissions are available for the sidelink transmissions, the second sidelink transmission is transmitted; if resources available for the sidelink transmissions among the determined resources cannot carry a third sidelink transmission, the third sidelink transmission is dropped, and/or if resources available for the sidelink transmissions among the determined resources can carry a fourth sidelink transmission, the fourth sidelink transmission is transmitted; determining dropped sidelink transmissions and/or transmitted sidelink transmissions among the sidelink transmissions according to a latency requirement; determining that one or more sidelink transmissions with low priorities among the sidelink transmissions are dropped, and determining that one or more sidelink transmissions with high priorities among the sidelink transmissions are transmitted; and determining dropped sidelink transmissions and/or transmitted sidelink transmissions among the sidelink transmissions according to the hybrid automatic repeat request (HARQ) state of the sidelink transmissions.

In some implementations, determining dropped sidelink transmissions and/or transmitted sidelink transmissions among the sidelink transmissions according to the hybrid automatic repeat request (HARQ) state of the sidelink transmissions comprises: determining that the retransmissions and/or the transmissions without HARQ enabled among the sidelink transmissions are dropped; and determining that an initial transmission among the sidelink transmissions is transmitted.

In some implementations, determining dropped sidelink transmissions and/or transmitted sidelink transmissions among the sidelink transmissions according to the latency requirement comprises: determining that one or more sidelink transmissions with larger remaining packet delay budgets (PDBs) and/or with later time point corresponding to the remaining PDBs among the sidelink transmissions are dropped, and/or determining that one or more sidelink transmissions with smaller remaining PDBs and/or with earlier time point corresponding to the remaining PDBs among the sidelink transmissions are transmitted.

In some implementations, determining resources for transmitting the sidelink transmissions comprises: determining resources for transmitting the sidelink transmissions based on whether the first node occupies a signal in resources whose number is greater than the number of resources required for the sidelink transmissions, and/or based on whether the resources whose number is greater than the number of resources required for the sidelink transmissions are reserved by other nodes.

In some implementations, the method further comprises: when candidate resources satisfying the first condition cannot be selected from the first candidate resources set, and/or the number of the selected candidate resources satisfying the first condition does not satisfy a threshold, it also comprises at least one of: increasing a reference signal received power (RSRP) threshold for determining the collision, and determining the resources for transmitting the sidelink transmissions based on the increased RSRP threshold; reducing a value of the number of multiple consecutive time units, and determining resources for transmitting the sidelink transmissions based on the reduced value; and in case that the number of the selected candidate resources satisfying the first condition does not satisfy the threshold, adding the selected candidate resources satisfying the first condition to a second candidate resources set, and reducing the value of the number of multiple consecutive time units, and then performing the determination the resources for transmitting the sidelink transmissions based on the reduced value until the number of the candidate resources in the second ser of candidate resources satisfies the threshold.

According to some embodiments of the present disclosure, a method performed by a second node in a communication system is provided, the method comprises: receiving sidelink transmissions transmitted by a first node; and determining that the sidelink transmissions are on resources including multiple consecutive time units.

In some implementations, determining that the sidelink transmissions are on resources including multiple consecutive time units comprises: receiving a first indication transmitted by a first node, the first indication indicates that the sidelink transmissions are on resources including multiple consecutive time units.

In some implementations, the method further comprises: receiving a second indication for the priorities of the sidelink transmissions; and determining the priorities of the sidelink transmissions based on the first indication and the second indication.

According to some embodiments of the present disclosure, a method performed by a first node device in a communication system is provided, the method comprises: determining resources for transmitting sidelink transmissions; and transmitting the sidelink transmissions on the determined resources, wherein the sidelink transmissions comprises data transmission and sidelink positioning signal transmission.

In some implementations, determining resources for transmitting sidelink transmissions comprises: dividing resources in resources pool into a plurality of sub-channel groups; and selecting resources in units of sub-channel group, and/or preferentially selecting complete sub-channel groups, and/or preferentially selecting resources that do not cross the boundaries of sub-channel groups.

In some implementations, the method further comprises: if the number of candidate resources in the candidate resources set does not satisfy a given threshold, adding resources including some sub-channels in the sub-channel groups and/or resources crossing the boundary of the sub-channel groups to the candidate resources set.

In some implementations, if the resources reserved by other nodes are detected in the candidate resources set and/or the resources selection window, the candidate resources reserved in the candidate resources set reported to the high layer are selected by at least one of: preferentially selecting the candidate resources adjacent to the resources reserved by other nodes in the frequency domain; if the number of candidate resources adjacent to the resources reserved by other nodes does not exceed a given threshold, continuing to select the candidate resources next adjacent to the resources reserved by other nodes in the frequency domain until the number of selected candidate resources satisfies the given threshold; if sub-channels are divided into sub-channel groups and the total number of candidate resources adjacent to resources reserved by other nodes does not exceed a given threshold, continuing to preferentially select candidate resources in the same sub-channel group as resources reserved by other nodes in frequency domain; preferentially selecting candidate resources in the same time unit as the resources reserved by the other nodes in the time domain; and if the resources pool is grouped for data and sidelink positioning signals, preferentially selecting the candidate resources in the group that match the type of one or more sidelink transmissions.

In some implementations, if the resources for sidelink positioning signals reserved by other nodes are detected in the candidate resources set, and the resources element (RE) patterns used by the resources for sidelink positioning signal are obtained, the candidate resources reserved in the candidate resources set reported to the high layer are selected by at least one of: if the resources for sidelink positioning signal reserved by other nodes include the candidate resources satisfying the following conditions: the RE patterns of the candidate resources do not overlap with that used by the resources reserved by other nodes, and the RE patterns of the candidate resources can be used for transmission of the sidelink positioning signal of the first node, the candidate resources with the same time-frequency resources or overlapping time-frequency resources with those reserved by other nodes are preferentially selected; and if the candidate resources satisfying the following conditions are not included in the sidelink positioning signal resources reserved by other nodes: the RE patterns of the candidate resources do not overlap with the RE patterns used by the resources reserved by other nodes, and the RE patterns of the candidate resources can be used for transmission of the sidelink positioning signal of the first node, and the sub-channels are divided into sub-channel groups, the candidate resources that are located in or include different sub-channel groups from the sidelink positioning signal resources reserved by other nodes are preferentially selected.

According to some embodiments of the present disclosure, a node device is also provided, which includes a transceiver; and a processor coupled to the transceiver and configured to perform the method of any one of the above descriptions.

The above and other features, aspects, and advantages of various embodiments of the present disclosure will be better understood with reference to the following description and appended claims. The drawings of the specification, which form a part of this disclosure, illustrate example embodiments of this disclosure, and together with the specification, serve to explain related principles. Details of one or more embodiments of the subject matter of the present disclosure are set forth in the accompanying drawings of the specification and the following description. Other potential features, aspects, and advantages of the subject matter of the present disclosure will also become clear from these descriptions, drawings, and claims.

### Advantageous Effects of Invention

The present disclosure may provide a method for SL communication based positioning and a device thereof in a wireless communication system.

The effects that can be achieved through the disclosure are not limited to the effects mentioned in the various embodiments, and other effects not mentioned will be clearly understood by those skilled in the art from the description below.

### BRIEF DESCRIPTION OF DRAWINGS

FIG. 1 illustrates an example wireless network 100 according to various embodiments of the present disclosure;

FIG. 2a illustrates an example wireless transmission and reception path according to the present disclosure;

FIG. 2b illustrates an example wireless transmission and reception path according to the present disclosure;

FIG. 3a illustrates an example UE according to the present disclosure;

FIG. 3b illustrates an example gNB according to the present disclosure;

FIG. 4a is a flowchart illustrating a method according to an example embodiment of the present disclosure;

FIG. 4b is a flowchart illustrating another method according to an example embodiment of the present disclosure;

FIG. 5a schematically illustrates a diagram of an example method for determining the candidate resources set for transmitting sidelink transmissions when the sidelink transmissions include sidelink positioning signal transmissions according to an example embodiment of the present disclosure; and

FIG. 5b schematically illustrates a diagram of another example method for determining the candidate resources set for transmitting sidelink transmissions when the sidelink transmissions include sidelink positioning signal transmissions according to an example embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

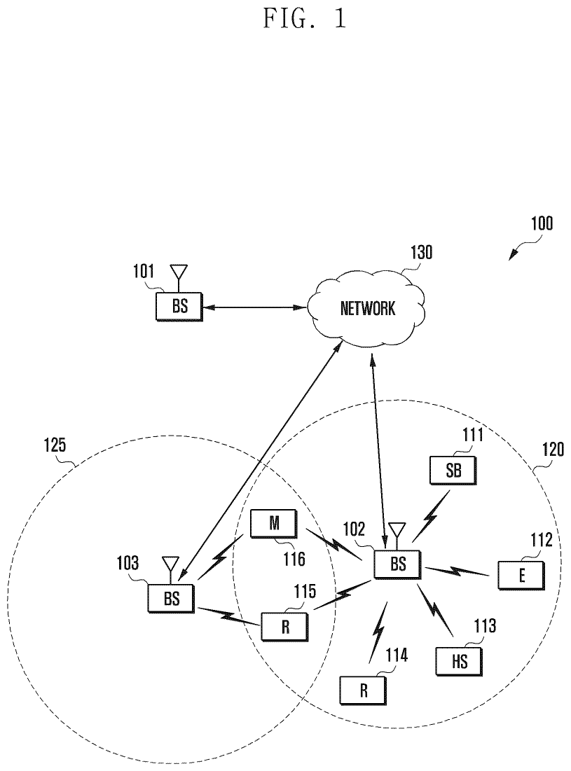

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

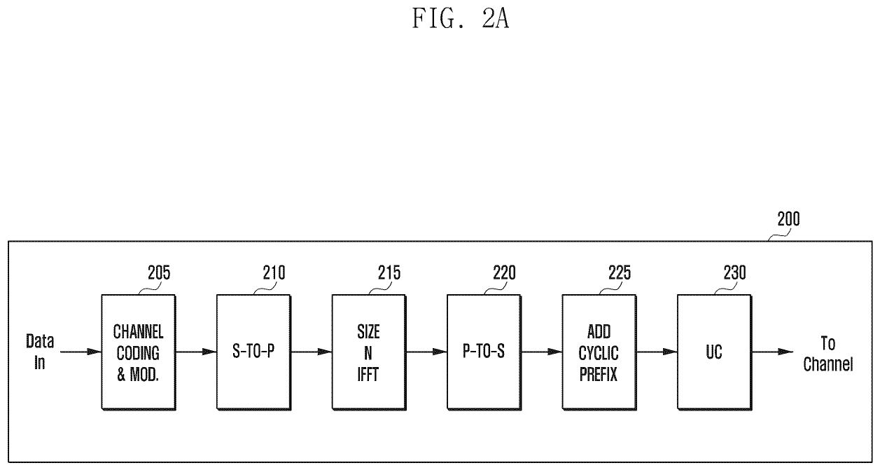

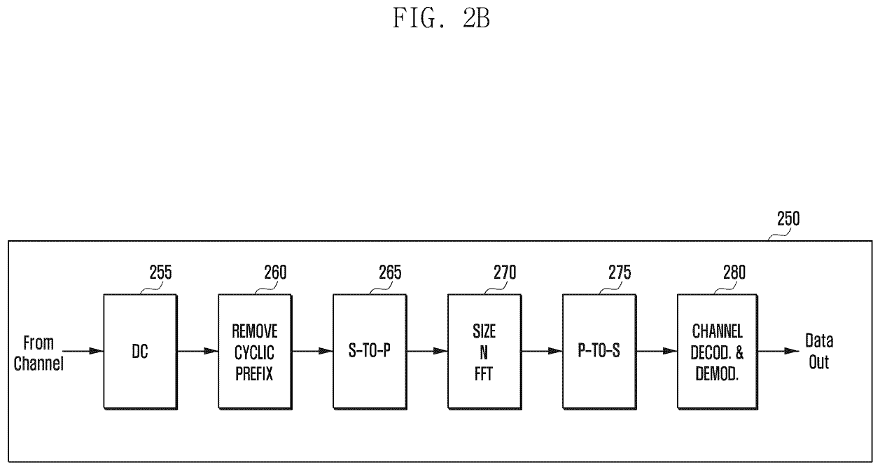

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116.

However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

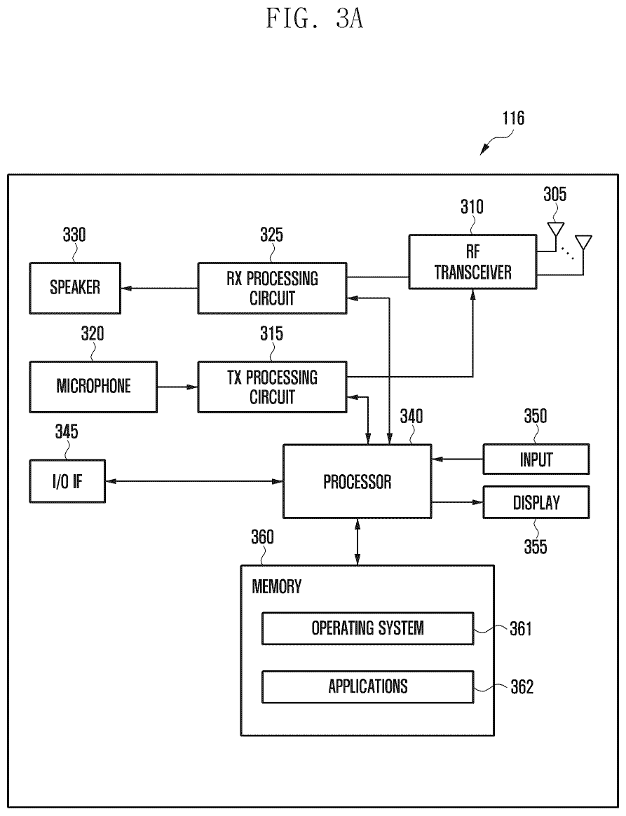

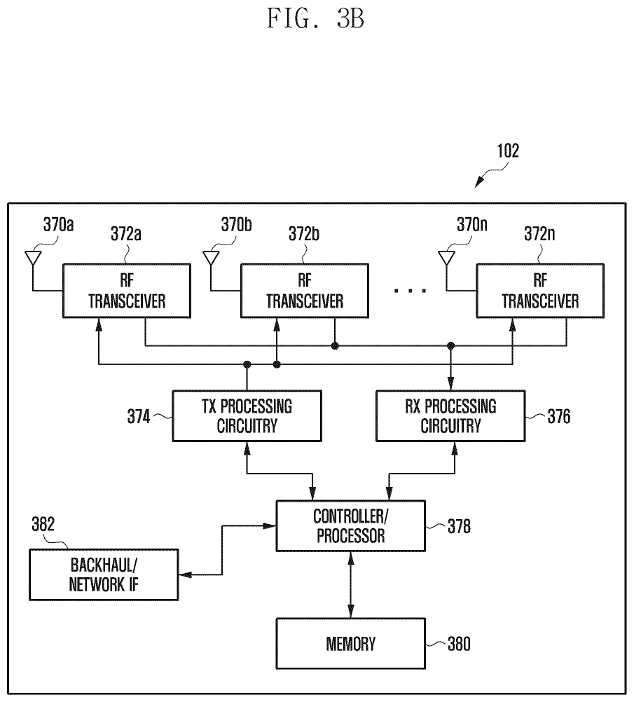

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In the Long Term Evolution (LTE) technology, sidelink communication includes two main mechanisms, which are Device to Device (D2D) direct communication and Vehicle to everything (Vehicle to Vehicle/Infrastructure/Pedestrian/Network, V2X), among which V2X is designed on the basis of D2D technology, which is superior to D2D in data rate, delay, reliability and link capacity, and is the most representative sidelink communication technology in LTE technology. In 5G system, sidelink communication mainly includes vehicle to everything (V2X) communication at present.

As the evolution technology of LTE, the 5G NR system also includes the further evolution of sidelink communication. As the evolution version of LTE V2X technology, NR V2X technology is formulated in version 16, and its performance in all aspects is superior. In Release 17, the 5G NR system is expected to further extend the application scenarios of NR V2X to other wider application scenarios, such as commercial sidelink communication and Public Safety (PS) scenarios. In Release 18, the evolution of sidelink communication includes support to directions such as unlicensed frequency band, FR2, carrier aggregation, co-channel coexistence with LTE, and technologies in other fields such as positioning.

In this embodiment of the application, the information configured by the base station, indicated by signaling, configured by the high layer and pre-configured includes a set of configuration information; also includes multiple sets of configuration information from which the UE selects a set of configuration information to use according to predefined condition; and also includes a set of configuration information containing a plurality of subsets from which the UE selects one subset to use according to predefined condition.

In the embodiment of this application, lower than a threshold can also be replaced by lower than or equal to a threshold, higher than(exceeding) a threshold can also be replaced by higher than or equal to a threshold, less than or equal to can also be replaced by less than, greater than or equal to or greater than; or vice versa.

Some technical solutions provided in the embodiment of this application are specifically described based on the V2X system, but its application scenario should not be limited to the V2X system in sidelink communication, but can also be applied to other sidelink transmission systems. For example, the design based on the V2X sub-channel in the following embodiments can also be used for the D2D sub-channel or other sub-channels of sidelink transmission. The V2X resource pool in the following embodiments can also be replaced by a D2D resource pool in other sidelink transmission systems, such as D2D.

In the embodiment of this application, when the sidelink communication system is a V2X system, the terminal or UE can be a Vehicle, an Infrastructure, a Pedestrian, and other types of terminals or UEs.

The base station in this specification can also be replaced by other nodes, such as sidelink nodes, and a specific example is the Road Side Unit (infrastructure)UE in the sidelink system. Any mechanism applicable to the base station in this embodiment can also be similarly used in the scenario where the base station is replaced by other sidelink nodes, and the description will not be repeated.

In this specification, slots can also be replaced with time units, candidate slots can also be replaced with candidate time units, and candidate single slot resources can also be replaced with candidate single time unit resources. In a specific example, the time unit can include a specific time length, such as several consecutive symbols.

The slot in this specification can be either a subframe or slot in the physical sense, or a subframe or slot the logical sense. Specifically, the subframe or slot in the logical sense is the subframe or slot corresponding to the resource pool of sidelink communication. For example, in the V2X system, the resource pool is defined by a repeated bitmap, which is mapped to a specific set of slots, the specific set of slots can be all slots, or all other slots except some specific slots (e.g., slots for transmitting Master Information Block (MIB)/System Information Block (SIB)). The slot indicated as “1” in the bitmap can be used for V2X transmission and belongs to the slot corresponding to the V2X resource pool; the slot indicated as “0” cannot be used for V2X transmission and does not belong to the slot corresponding to the V2X resource pool.

The following is a typical application scenario to illustrate the difference between physical or logical subframes or slots: when calculating the time domain gap between two specific channels/messages (such as PSSCH carrying sidelink data and PSFCH carrying corresponding feedback information), it is assumed that the gap is N slots. If physical subframes or slots are calculated, the N slots correspond to the absolute time length of N*x milliseconds in the time domain, and x is the time length of the physical slot (subframe) under the numerology of the scenario in millisecond. Otherwise, if the logical subframes or slots are calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot in this specification can be a complete slot or several symbols corresponding to sidelink communication in one slot. For example, when the sidelink communication is configured to be performed on the X1~X2 symbols of each slot, the slot in the following embodiment is the X1~X2 symbols in the slot in this scenario; alternatively, when the sidelink communication is configured as mini-slot transmission, the slot in the following embodiments is mini-slot defined or configured in the sidelink system rather than the slot in the NR system; alternatively, when the sidelink communication is configured as symbol level transmission, the slots in the following embodiments can be replaced with symbols, or can be replaced with N symbols with time domain granularity as symbol level transmission.

In order to make the purpose, technical solutions and advantages of this application clearer, the embodiment of this application will be further described in detail with the accompanying drawings.

Text and drawings are only provided as examples to help readers understand this disclosure. They are not intended and should not be construed to limit the scope of the present disclosure in any way. Although some embodiments and examples have been provided, based on the disclosure herein, it is obvious to those skilled in the art that changes can be made to the illustrated embodiments and examples without departing from the scope of this disclosure.

In the LTE sidelink communication system and the NR V2X system of version 16, the frequency domain resources for sidelink communication are usually located in the licensed frequency bands. Generally, it is assumed that there is substantially no interference from other external communication systems (such as WiFi, Bluetooth, etc.) on such frequency bands. However, for the sidelink communication system operating in the unlicensed frequency bands, it is necessary to consider the interference of other communication systems on the unlicensed bands, and it is also necessary to limit the interference of the sidelink communication to other communication systems according to regulation.

In the NR-unlicensed (NR-U) system of versions 15 and 16, Listen Before Talk (LBT) is adopted as one of the typical technologies in the unlicensed frequency bands. In this technology, a special frame structure is defined for the NR communication system in the unlicensed frequency bands, and the frame structure contains several gaps for LBT. UE and base station need to perform LBT before uplink and downlink transmission, and can transmit all kinds of wireless signals/channels normally only after LBT is passed. In this embodiment, a method for applying LBT technology to sidelink the communication system is provided.

In a communication system in unlicensed frequency bands, channel occupancy (CO) refers to the transmitting on the corresponding channel after the base station/UE performs the channel access process, and channel occupancy time (COT) refers to the total time for the base station/UE and the base station/UE sharing the channel occupancy to transmit on the corresponding channel after performing the channel access process. Both the base station and/or the sidelink UE can initialize a COT and share the COT with other base stations and/or the sidelink UE. After initializing a COT or obtaining a COT shared by base stations/other nodes, UE needs to determine the structures and positions of sidelink resources within the COT. In this embodiment, a specific method for UE to determine the structures and positions of sidelink resources within COT is explained.

In NR-Unlicensed (NR-U) technology, the structure of uplink/downlink resources within COT can be embodied by uplink/downlink burst, wherein the uplink/downlink burst is a transmission set from a base station or UE, and there is no gap exceeding a certain length. Similar to the existing definition of uplink/downlink bursts, the structure of sidelink resources within COT can also be embodied by a sidelink burst, wherein the sidelink burst is a transmission set from UE, and there is no gap exceeding a certain length (for example, 16 us). Optionally, one burst may include only transmissions from the same UE; or, one burst may include transmissions from the same or different UE. Optionally, one burst may include only one or more specific signals/channels; For example, one burst may include only physical sidelink control channel, PSCCH, and/or physical sidelink shared channel, PSSCH, another burst may include only physical sidelink feedback channel, PSFCH, or one burst may include PSCCH, PSSCH and PSFCH. Alternatively, similar to the existing discovery burst, the sidelink synchronization signal, the sidelink synchronization channel and the sidelink reference signal (which can be a specific type of reference signal/a reference signal satisfying specific conditions) correspond to the sidelink discovery burst instead of the general sidelink burst.

In the sidelink communication technology, from the perspective of resources allocation, there are two modes in the 5G sidelink communication system: resources allocation mode based on base station scheduling and resources allocation mode selected autonomously by UE. In the 5G V 2X system, the resources allocation mode based on base station scheduling and the resources allocation mode selected autonomously by UE are named as mode 1 and mode 2 respectively. For the resources allocation mode 2, the method for sidelink UE selecting resources autonomously is that the UE keeps monitoring and caching the sidelink resources pool, and determines a channel sensing time window and resources selection time window according to the expected time range for transmitting the sidelink transmissions before the sidelink transmissions needed to be transmitted, performs channel sensing in the channel sensing time window, excludes the sidelink resources reserved by other sidelink UEs in the resources selection time window according to the channel sensing result, and randomly selects the sidelink resources for sidelink transmissions from the sidelink resources that are not excluded in the resources selection time window. When the mechanism operates in the unlicensed frequency bands, due to the characteristics of the unlicensed frequency bands, the mechanism needs to be modified accordingly to adapt to the uncertainty brought by the channel pre-emption mechanism based on COT sharing and LBT in the unlicensed frequency bands, and make the operation of sidelink communication in the unlicensed frequency bands not violate the restrictions of regulations.

Text and drawings are only provided as examples to help readers understand this disclosure. They are not intended and should not be construed to limit the scope of the present disclosure in any way. Although some embodiments and examples have been provided, based on the disclosure herein, it is obvious to those skilled in the art that changes can be made to the illustrated embodiments and examples without departing from the scope of this disclosure.

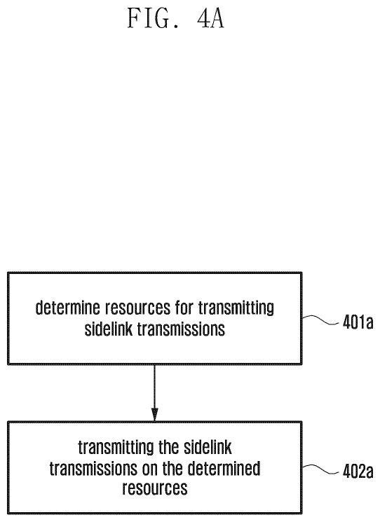

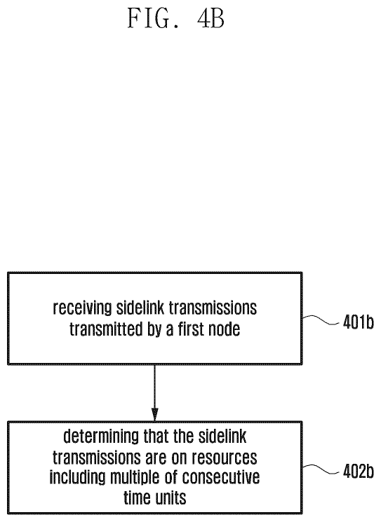

FIG. 4a is a flowchart illustrating a method according to an example embodiment of the present disclosure, which includes the following steps:
step 401a: determining resources for transmitting sidelink transmissions.
step 402a: transmitting the sidelink transmissions on the determined resources, wherein if the determined resources include multiple consecutive time units and N time units of the multiple consecutive time units unavailable for the sidelink transmissions, at least one of the sidelink transmissions is transmitted on time units available for the sidelink transmissions of the multiple consecutive time units, and/or at least one of the sidelink transmissions is transmitted on time units other than the multiple consecutive time units and consecutive with the time units available for the sidelink transmissions of the multiple consecutive time units, wherein N is an integer greater than or equal to 1; and/or
the determined resources are determined among resources whose number is greater than the number of resources required for the sidelink transmission; and/or
the determined resources are the candidate resources satisfying a first condition in a first candidate resources set, wherein the first condition includes that the candidate resources include multiple consecutive time units and each time unit does not include-physical sidelink feedback channel (PSFCH) resource.

FIG. 4b is a flowchart illustrating another method according to an example embodiment of the present disclosure, which includes the following steps:
step 401b: receiving sidelink transmissions transmitted by a first node.
step 402b: determining that the sidelink transmissions are on resources including multiple consecutive time units.

Sidelink communication system is restricted by regulations when operating in the unlicensed frequency bands. After selecting the resources for the sidelink transmissions, if there is a gap exceeding a certain length before the transmissions, UE needs to perform LBT process first, and the transmissions can be transmitted only when LBT successes, otherwise the transmissions cannot be transmitted. Therefore, when the UE needs to transmit a plurality of sidelink signals/channels, in order to reduce the impact of potential failure of LBT on transmission, the UE can select multiple consecutive slots in the resources allocation process, to transmit the plurality of sidelink signals/channels respectively. This method is also called multi-consecutive slots transmission (MCSt), and the slot can also be replaced by other time unit.

For MCSt technology, it will also encounter the problem that the sidelink signals/channels cannot be transmitted on the initial slots due to failure of LBT. Unlike the uplink and downlink transmissions in the unlicensed frequency bands are scheduled by the base station, the resources for the sidelink transmissions are selected by the UE itself, and how to transmit sidelink signals/channels on the selected resources can also be determined by the UE itself. Therefore, it is necessary to design a corresponding UE-side processing method for the failure of LBT in the unlicensed frequency bands, especially the failure of LBT for MCSt.

In an exemplary embodiment, the first UE selects multiple consecutive slots (in this embodiment and other embodiments of this specification, slot can also be replaced by other time unit, and will not be described everywhere) for sidelink transmissions. The sidelink transmissions may include multiple retransmissions of one sidelink transmission, and/or may include a plurality of different sidelink transmissions. When multiple consecutive slots are determined for sidelink transmission, the first UE uses at least one of methods to perform sidelink transmissions on the multiple consecutive slots:
indicates that the sidelink transmissions are on multiple consecutive slots; further, including explicitly indicates that the sidelink transmissions are on multiple consecutive slots, for example, indicates that the transmissions scheduled by SCI are based on MCSt through a 1-bit field in SCI; and/or, including implicitly indicates that the sidelink transmissions are on multiple consecutive slots, for example, indicates multiple consecutive slots through the time domain resources indication field in SCI (the existing indication method can be reused or a new indication method can be used) so as to implicitly indicate that the transmissions scheduled by SCI are based on MCSt;
adjusts the priorities of sidelink transmissions on the multiple consecutive slots; optionally, this method is used in the case that the first N slots of the multiple consecutive slots are unavailable for the sidelink transmissions, or N slots of the multiple consecutive slots are unavailable for the sidelink transmissions;
if the first N slots of the multiple consecutive slots are unavailable for the sidelink transmissions, or N slots of the multiple consecutive slots are unavailable for the sidelink transmissions, delays the slots occupied by the sidelink transmissions, further, delays for N slots or up to N slots;
if the first N slots of the multiple consecutive slots are unavailable for the sidelink transmissions, or N slots of the multiple consecutive slots are unavailable for the sidelink transmissions, drops the sidelink transmissions on N slots; further, determines which of the above sidelink transmissions to drop;
if the multiple consecutive slots include M consecutive slots, and the first N slots are unavailable for the sidelink transmission, or the N slots are unavailable for the sidelink transmissions, determines which of the above sidelink transmissions to transmit based on the slots and/or resources available for the sidelink transmissions; further, determines which of the above sidelink transmissions to transmit on the remaining M-N slots;
reselects resources for that sidelink transmissions; including reselects resources on a total of N slots for the sidelink transmission, and further, the N slots are consecutive; and/or including reselects resources for the sidelink transmissions that cannot be transmitted on the multiple consecutive slots among the sidelink transmission, and further including reselects resources for the sidelink transmissions that are dropped among the sidelink transmission.

The method for adjusting the priorities of sidelink transmissions on the multiple consecutive slots further comprises at least one of:
when the sidelink transmissions are on multiple consecutive slots, the priorities of the sidelink transmissions are set to the priorities configured by the high layer (and/or the priorities when the sidelink transmissions are not on multiple consecutive slots) plus an offset, the offset can be (pre-) configured and/or preset;
when the sidelink transmissions are on multiple consecutive slots and include a plurality of sidelink transmissions, the priorities of the plurality of sidelink transmissions are set as the highest one among the plurality of sidelink transmissions; further, the method can be used in combination with other methods, for example, sets the priorities of the plurality of sidelink transmissions as the highest one among the priorities of the plurality of sidelink transmissions configured by high layer plus an offset;
when the sidelink transmissions are on multiple consecutive slots, adjusts the priorities of the sidelink transmissions on each of the multiple consecutive slots;
when the sidelink transmissions are on multiple consecutive slots, and the consecutive slots include delayed slots, adjusts the priorities of the sidelink transmissions on the delayed slots.

The method for adjusting the priorities can be performed by a first UE, and further, the adjusted priorities are indicated by the first UE after the adjustment, so that the adjustment is transparent to the second UE. The method can also be performed by a second UE. For example, the first UE indicates the unadjusted priorities and information related to MCSt (and may also indicates information related to delayed transmissions), and the second UE adjusts the priorities based on the above information. The specific method is shown in other subsequent embodiments.

For the above method of delaying the slots occupied by the sidelink transmissions, the first N slots or N slots of the multiple consecutive slots are unavailable for the sidelink transmissions including at least one of: fails to occupy the channels on the N slots, and further including the failure of LBT on the N slots; the N slots are reserved by other UEs, further comprising determines that the resources selected on the N slots are unavailable based on re-evaluation and/or pre-emption on the N slots.

For the above method of delaying the slots occupied by the sidelink transmissions, further, when the UE determines that there are resources available for the sidelink transmissions on the delayed N (or at most N) slots through the sidelink resource determination process, delays the slots occupied by the sidelink transmissions; otherwise, no delay. Further, the UE delays the slots occupied by the sidelink transmissions for up to N, and delays to the slots on which there are resources for sidelink transmission, and/or delays to the slots on which there are no resources for sidelink transmission. In a specific example, the UE selects the resources on slots 0, 1, 2 and 3 for the transmissions of four PSSCHs respectively, but the resources on slots 0 and 1 are unavailable for the transmissions of PSSCHs due to the failure of LBT, so the UE delays the transmissions of the four PSSCHs to slots 2, 3, 4 and 5. In this example, slots 4 and 5 can be considered as delayed slots, and slots 2 and 3 can be considered as non-delayed slots or previously selected slots; the main purpose of this description is to facilitate the relevant description in the subsequent methods, and should not limit the scope of protection. In another specific example, the UE selects the resources on slots 0, 1, 2 and 3 for transmissions of four PSSCHs respectively, but the resources on slots 0 and 1 are unavailable for the transmissions of PSSCHs due to the failure of LBT; if the UE finds that there are resources available for the above-mentioned PSSCH transmissions (which can be at least one of the above-mentioned four PSSCH transmissions) on the slot 4 and there are no resources available for the above-mentioned PSSCH transmissions on the slot 5 through the resources selection process, the UE will delay the transmissions of the four PSSCHs to the slots 2, 3 and 4.

For the method of determining which of the above-mentioned sidelink transmissions to transmit based on slots and/or resources available for the above-mentioned sidelink transmissions, and/or for the method of determining which of the above-mentioned sidelink transmissions are dropped, the method further comprises at least one of:
according to the initial order of the plurality of sidelink transmissions, drops the sidelink transmissions whose the selected resources on the slots and/or resources that are unavailable for the sidelink transmissions, and transmits the sidelink transmissions on the remaining resources;
according to which sidelink transmissions can be carried on the slots and/or resources available for the sidelink transmissions (for example, whether the sizes of the resources is not smaller than the sizes of the resources required for the sidelink transmission, the sizes of the resources can be indicated by the high layer and/or determined based on parameters such as MCS and TBS), determines to transmit the sidelink transmissions that can be carried on the slots and/or resources available for the sidelink transmissions, and/or drops the sidelink transmissions that cannot be carried; in a specific example, the UE selects four resources located in four consecutive time units according to parameters such as frequency domain size indicated by the high layer, and the sizes of the four resources are f1, f2, f3, f4 and f4 in frequency domain, respectively. For the size f in frequency domain required for any one of a plurality of sidelink transmissions, if f<=f1, it is considered that the sidelink transmissions can be carried on the first resource, and so on;
determines according to the latency requirement, for example, determines according to the remaining PDBs. For example, the sidelink transmissions with smaller remaining PDBs and/or earlier time point corresponding to the remaining PDBs are preferentially transmitted; for another example, the sidelink transmissions with larger remaining PDBs and/or later time point corresponding to the remaining PDBs are preferentially dropped. Specifically, transmitting sidelink transmissions with smaller remaining PDBs among one or more sidelink transmissions can be transmitting the sidelink transmission with the smallest remaining PDB, or transmitting several sidelink transmissions with smaller remaining PDBs, for example, sidelink transmissions with the top three smallest remaining PDB among one or more sidelink transmissions. Similarly, transmitting sidelink transmissions with the earlier time point corresponding to the remaining PDBs among one or more sidelink transmissions can be transmitting the sidelink transmission with the earliest time point corresponding to the remaining PDBs, or the sidelink transmissions with the relative earlier time point corresponding to the remaining PDBs, for example, the sidelink transmissions with the top three earlies time point corresponding to the remaining PDBs among one or more sidelink transmissions. Similar explanation can also be made for the larger remaining PDBs and the later time point corresponding to the remaining PDBs. Wherein the sidelink transmissions with smaller remaining PDBs and/or earlier time point corresponding to the remaining PDBs refer to the sidelink transmissions with smaller remaining PDBs compared to other sidelink transmissions transmitted on the above-mentioned resources, and/or the sidelink transmissions with later time point corresponding to the remaining PDBs compared to other sidelink transmissions transmitted on the above-mentioned resources. In a specific example, the UE selects resources on four consecutive slots for transmitting four sidelink transmissions, and the remaining PDBs of the four sidelink transmissions are P1, P2, P3, P4 and P4, and P4>P3>P2>P1; due to the failure of LBT, the resources on the first two consecutive slots are unavailable for the sidelink transmissions, and the resources on the last two consecutive slots are available for the sidelink transmissions; then the UE transmits two sidelink transmissions with smaller remaining PDBs, that is, two sidelink transmissions with remaining PDBs of P1 and P2 respectively. Further, when this method is combined with the above-mentioned method of delaying the slots occupied by the sidelink transmissions, the transmissions with larger remaining PDBs and/or a later time point corresponding to the remaining PDBs are transmitted on the delayed resources, the advantage of this method is that even if these transmissions are not successfully received, there is sufficient time for retransmission;
determines according to the priorities. For example, preferentially transmitting sidelink transmissions with higher or lower priorities; for another example, the sidelink transmissions with lower priorities are dropped first. Further, when this method is combined with the above method of delaying the slots occupied by the sidelink transmissions, the transmissions with relatively low priorities are transmitted on the delayed resources, and the transmissions with relatively high priorities are transmitted on the previously selected resources. The advantage of this method is that the previously selected resources possess high reliability, which is helpful for the transmissions with higher priorities and importance to be transmitted successfully. Or, the transmissions with relatively high priorities are transmitted on the delayed resources, and the transmissions with relatively low priorities are transmitted on the previously selected resources. The advantage of this method is that if the transmissions with higher priorities conflict with the transmissions of other UEs, it is more likely to trigger other UEs to drop their transmissions and reselect unconflicted resources, thus the UE is more likely to transmit more transmissions. Wherein the sidelink transmissions with lower priorities refer to the sidelink transmissions with lower priorities than other sidelink transmissions among the sidelink transmissions that need to be transmitted on the above resources; sidelink transmissions with higher priorities are vice versa. In a specific example, the UE selects resources on four consecutive slots for transmitting four sidelink transmissions, and the priorities of the four sidelink transmissions are 0, 1, 2 and 3 respectively; due to the failure of LBT, the resources on the first two consecutive slots are unavailable for the sidelink transmissions, and the resources on the last two consecutive slots are available for the sidelink transmissions. The UE transmits two sidelink transmissions with higher priorities on the previously selected resources, that is, transmits two sidelink transmissions with priorities of 0 and 1 respectively; transmits two sidelink transmissions with lower priorities on the delayed resources, that is, transmits two sidelink transmissions with priorities of 2 and 3 respectively;
determines according to the HARQ state, including whether the sidelink transmissions is HARQ-enabled and/or whether the sidelink transmission is an initial transmission or retransmission. For example, the retransmission is dropped preferentially, and/or the transmissions without HARQ are dropped preferentially; for another example, blind retransmission is dropped preferentially, that is, retransmission in transmission without HARQ is dropped preferentially. The advantage of this method is that retransmissions with uncertainty of whether needed to be transmitted are reduced by dropping the blind retransmission, so that the initial transmission can be transmitted first, and the receiving UE has the opportunity to parse more data.

In the process of resources determination based on sensing, when UE determines the resources used by a sidelink transmission, if periodic resources reservation is allowed in the resources pool, the UE should try to avoid the resources occupied by the sidelink transmissions from conflicting with other UEs in current period, as well as try to avoid the resources occupied by the sidelink transmissions from conflicting with other UEs in future period. Therefore, in the case that some resources in the MCSt are unavailable (for example, in the case of LBT fails) and/or in the case that resources delay caused by the unavailability of some resources, the UE can still try to use the resources selected in the resource determination process for the sidelink transmissions in other periods, although the resources used in the current period are not completely consistent with the resources selected in the resource determination process, so as to obtain the effect of avoiding conflicts in the resources selection process as far as possible. Accordingly, when UE is required to indicate reserved resources in SCI, design of SCI can support the indication method for different situations of using resources in the next period and the current period.

In an exemplary embodiment, the first UE transmits sidelink transmissions in slot n, and indicates the time domain resources T, the value of the period P and the offset O in the SCI associated with the sidelink transmissions. The resources indicated by the SCI of the first UE include resources on time domain resources n+T and resources on time domain resources n+T+P+O, wherein the resources on n+T can be used as resources reservation for the current period and the resources on n+T+P+O can be used as resources reservation for the next period. The indication to n+T and/or the indication to P can reuse the method of indicating these two parameters in the licensed frequency bands; O can be indicated by adding an explicit bit field, and/or can be indicated implicitly, including that determines the value of O through the indication of the resources delay of the sidelink transmissions by the first UE.

In an exemplary embodiment, the second UE detects the sidelink transmissions of the first UE and determines that the sidelink transmissions are based on MCSt or on multiple consecutive slots. For example, the second UE determines based on the indication of the first UE indicating the sidelink transmissions are on multiple consecutive slots. Optionally, the second UE determines the priorities of the sidelink transmissions based on the priorities of the sidelink transmissions indicated by the first UE and the sidelink transmissions being based on MCSt. Optionally, when at least one time-frequency resources used by the sidelink transmissions overlaps with the time-frequency resources used by the second UE for transmission and/or reception, and/or when the second UE detects a conflict on the at least one time-frequency resources used by the sidelink transmissions, the second UE determines the priorities of the sidelink transmissions based on the priorities of the sidelink transmissions indicated by the first UE and the sidelinks transmissions being based on MCSt.

Further, the second UE detects the sidelink transmissions of the first UE and determines that the sidelink transmissions are based on MCSt or on multiple consecutive slots, and at least one time-frequency resources used by the sidelink transmissions overlaps with that used by the second UE for transmission and/or reception, and/or the second UE detects a conflict on the at least one time-frequency resources used by the sidelink transmissions, then the second UE uses at least one of methods:
delays the sidelink transmissions on the resources used by the second UE for transmission, optionally until there is no overlap or collision;
the second UE drops its transmissions on the overlapped resources; optionally, the second UE determines whether to drop the transmissions on the overlapped resources based on the priorities, or the second UE preferentially drops the transmissions that are not based on MCSt/the transmissions that are not on multiple consecutive slots when detecting that the MCSt-based transmissions/the transmissions on multiple consecutive slots of other UE uses the overlapped resources;
the second UE transmits a conflict indication and indicates in the conflict indication that the reason of the conflict is related to MCSt. Optionally, a specific bit value and/or a specific resource of the PSFCH (for example, code domain resources corresponding to a specific state, the code domain resources can be embodied by the value of m0 or mcs) indicates that the reason of the conflict is related to MCSt.

Considering the potential risk of the failure of LBT, in the process of resources determination, the UE can select more resources than actually needed at one time, so that when some resources are unavailable due to the failure of LBT or conflict, the remaining resources are still enough to complete the transmission. Since the UE will indicate the resources reservation only when actually transmitting the sidelink channel, for the MCSt method, the UE can only indicate the resources actually used after selecting more resources than actually needed. Therefore, there is not waste of resources, and no additional resources release mechanism is required.

In an exemplary embodiment, if the UE needs to transmit sidelink transmissions on N slots (further, N consecutive slots), the UE selects M slots (further, M consecutive slots) in the resource determination process, wherein M>N. Optionally, when generating the candidate resources set, the UE preferentially adds the candidate resources including M slots to the candidate resources set, and if the total number of candidate resources including M slots does not satisfy a preset threshold (the threshold can be Mtotal, which is used to limit the minimum number of resources included in the candidate resources set reported to the high layer, and the main effect of the threshold is to ensure that there are enough candidate resources in the set to ensure randomness), the UE continues to add the candidate resources including N slots. Optionally, when the UE generates the candidate resources set, if the total number of candidate resources including M consecutive slots and/or candidate resources including N consecutive slots does not satisfy the preset threshold, it will continue to add inconsecutive candidate resources, which may include M or N slots.

The main advantage of using MCSt in the unlicensed frequency bands is that by selecting consecutive resources, UE can transmit without gap, thus avoid from introducing additional LBT between a plurality sidelink transmissions. However, when there is are PSFCH resources among the resources used by multiple sidelink transmissions, the UE may need to transmit sidelink transmissions-receive PSFCH-transmit sidelink transmissions on the resources, or transmit sidelink transmissions-keep silent on PSFCH resources-transmit sidelink transmissions, so this method actually fails to benefit from the MCSt. Therefore, the MCSt in the unlicensed frequency bands can be additionally enhanced.

In this specification, for the convenience of description, when the candidate resources in the resources selection process includes N consecutive slots, and/or when a plurality of candidate resources in the resources selection process include N consecutive slots, it is called N-slots candidate resources.

In an exemplary embodiment, when the UE selects multiple consecutive slots for sidelink transmission, it selects multiple consecutive slots in that do not include the PSFCH resources therein. When UE selects N-slots candidate resources for sidelink transmission, it selects N-slot candidate resources that do not include PSFCH resources in the N slots or the first N−1 slots of the N slots.

Optionally, when the UE cannot select the N-slot candidate resources that do not include the PSFCH resources therein (the number of the selected N-slots candidate resources that do not include the PSFCH resources therein does not satisfy a threshold requirement), the UE uses at least one of methods:
increases the reference signal receiving power, RSRP, threshold for determining the conflict;
decreases the value of N;
selects K-slots candidate resources, wherein K<N; further, when the number of N-slots candidate resources excluding PSFCH resources does not satisfy the threshold requirement of the number of resources in the candidate resources set, K-slots candidate resources are added to the candidate resources set, wherein K<N; further, the value of K starts from K=N−1, K=N−2, and so on until the threshold requirement is met.

When the sidelink transmissions include data transmissions and positioning signal transmissions, the traditional resources selection method designed for sidelink data is no longer completely suitable because the bandwidth occupied by positioning signals is often much larger than data. A typical problem is that due to the sidelink transmissions of smaller size freely select any resources that are not reserved in the resources pool, which may lead to the fragmentation of resources, that is, the frequency domain resources occupied by other UEs are distributed inconsecutively. Although the total number of remaining available frequency domain resources exceeds the demand of sidelink positioning signal transmission, it is impossible to find consecutive frequency domain resources with sufficient size in the frequency domain, thus causing a waste of resources. Therefore, it is necessary to consider how to enhance the autonomous resources determination method of the sidelink UE, so that the UE can select the sidelink resources with more reliable performance and bandwidth satisfying the requirements of the positioning signal to transmit the sidelink positioning signal.

In an exemplary embodiment, the time domain and/or frequency domain resources in the resources pool are further divided into several groups, for example, starting from sub-channel 0, every N sub-channels are divided into one sub-channel group. When UE selects the resources for sidelink transmission, it selects in units of sub-channel groups. Further, the UE always selects according to the sub-channel group, or preferentially selects the complete sub-channel groups and/or preferentially selects the resources that do not cross the boundaries of the sub-channel groups. For the former, the UE performs sensing-based resource determination process or random selection process in unit of sub-channel group. For the latter, when the UE selects the candidate resources in the candidate resources set in the resource determination process, the candidate resources including the complete sub-channel groups are preferentially added to the candidate resources set; if the number of candidate resources in the candidate resources set does not satisfy the corresponding threshold, continues to add candidate resources including some sub-channels in the sub-channel groups and/or candidate resources crossing the boundaries of the sub-channel groups to the candidate resources set. Optionally, the method is used when the UE selects resources for the transmissions of sidelink positioning signals (including SL-PRS); and/or the method is used when the UE selects resources for sidelink transmissions with frequency domain size exceeds a threshold; and/or the method is used when sidelink positioning signals and sidelink data coexist in the same resources pool and/or the method is used when sidelink positioning signals with different frequency domain sizes are transmitted in the same resources pool.

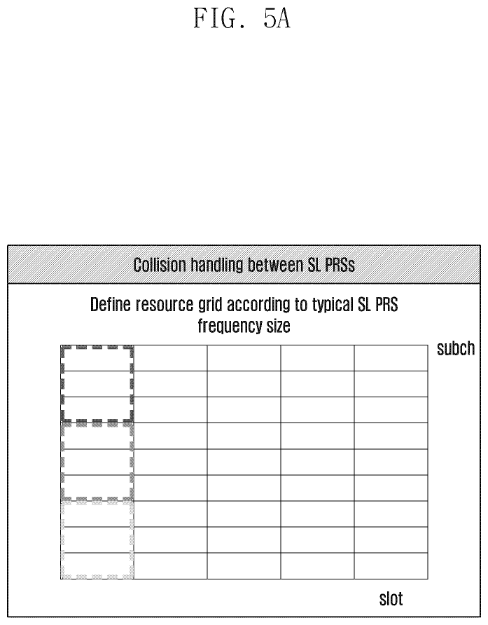

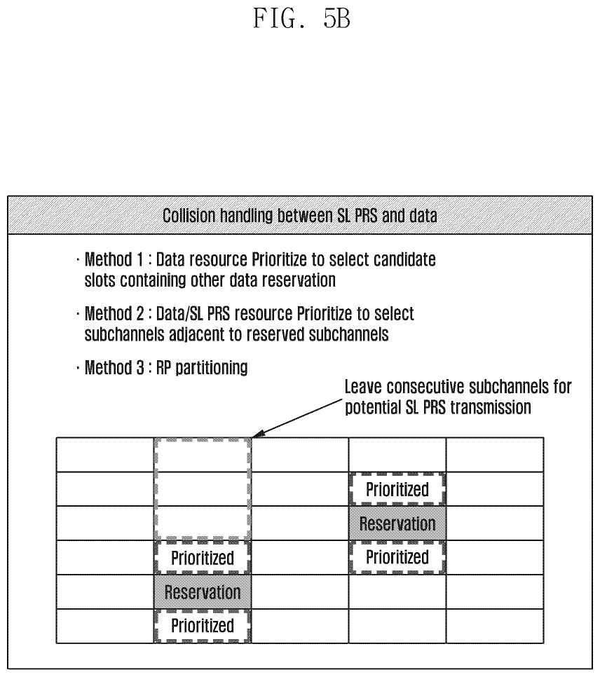

FIG. 5a schematically illustrates an example of selecting sidelink transmissions for transmitting sidelink positioning signal transmissions. In an example, sub-channels {0, 1, 2} {3, 4, 5} {6, 7, 8} are divided into three sub-channel groups respectively, and when the UE selects the candidate resources, candidate resources whose frequency domain resources are sub-channels {0, 1, 2} {3, 4, 5} {6, 7, 8} are preferentially added to the candidate resources set; if the number does not satisfy the threshold, continues to add the candidate resources whose frequency domain resources cross the boundaries of the sub-channel groups to the candidate resources set, for example, the candidate resources whose frequency domain resources are sub-channels {2, 3, 4} {5, 6, 7}.

FIG. 5b schematically illustrates another example of selecting sidelink transmissions for transmitting sidelink positioning signal transmissions. In an exemplary embodiment, when the UE selects the candidate resources in the candidate resources set in the resources selection process, if resources reserved by other UEs are detected in the candidate resources set and/or the resources selection window, at least one of methods is used to select the candidate resources that are reserved in the candidate resources set reported to a high layer:
preferentially selects candidate resources adjacent to the resources reserved by other UEs in frequency domain;
if the total number of candidate resources adjacent to the resources reserved by other UEs does not exceed a given threshold, continues to select the candidate resources that are next adjacent to the resources reserved by other UEs in frequency domain (for example, the resources reserved by other UEs are in sub-channel n, the candidate resources adjacent to them are in sub-channels n−1 and n+1, and the candidate resources next adjacent to them are in sub-channels n−2 and n+2), and so on;
if the sub-channels are divided into sub-channel groups, and the total number of candidate resources adjacent to the resources reserved by other UEs does not exceed a given threshold, continues to preferentially select the candidate resources in the same sub-channel group as the resources reserved by other UEs in the frequency domain;
preferentially selects the candidate resources in the same slot as the resources reserved by other UEs in the time domain;
if the resources pool is grouped for data and the sidelink positioning signals, preferentially selects the candidate resources in the groups consistent with the types of the sidelink transmissions (data or sidelink positioning signals, in which the sidelink measurement report can be preset to belong to the data or the sidelink positioning signals).

Optionally, according to at least one of the above methods, select the candidate resources reserved in the candidate resources set reported to the high layer until the number of candidate resources in the candidate resources set exceeds a given threshold; otherwise, if the number of candidate resources in the candidate resources set fails to exceed the given threshold after performing the above method, the RSRP threshold for determining the conflict is increased, and the above method is performed again.

When UE determines the resources for transmitting the sidelink positioning signal based on sensing, different UEs can select the sidelink positioning reference signal (SL PRS) resources with orthogonal resources element (RE) patterns on the same time-frequency resources (such as slots and sub-channels) to transmit their sidelink positioning signals respectively. Since the RE used by the sidelink positioning signals of different UEs are orthogonal to each other, it can be considered that there is no conflict in their transmissions. In order to ensure that RE patterns used by different UE possess better orthogonality, the time-frequency resources used in their transmissions need to have a certain correspondence.

In an exemplary embodiment, when the UE selects the candidate resources in the candidate resources set in the resources selection process, if SL PRS resources reserved by other UEs are detected in the candidate resources set, and the RE patterns used by the resources can be parsed, at least one of methods is used to select the candidate resources that are reserved in the candidate resources set reported to the high layer:
if the SL PRS resources reserved by other UEs include the candidate resources satisfying the following conditions: the RE patterns of the candidate resources do not overlap with the RE patterns used by the resources reserved by other nodes; and the RE patterns of the candidate resources can be used for the transmissions of the UE's own SL PRS (for example, its granularities/patterns conform to the requirements of its own SL PRS or the parameters of its own SL PRS), preferentially selects the candidate resources with time-frequency resources same as the SL PRS resources reserved by other UEs or time-frequency resources overlapping with the SL PRS resources reserved by other UEs;
if the SL PRS resources reserved by other UEs do not include the candidate resources satisfying the following conditions: the RE patterns of the candidate resources do not overlap with the RE patterns used by the resources reserved by other nodes; and the RE patterns of the candidate resources can be used for the transmissions of the UE's own SL PRS, and the sub-channels are divided into sub-channel groups, preferentially selects the candidate resources located in/including sub-channel groups different from the SL PRS resources reserved by other UEs.

In the case that the UE selects multiple consecutive slots for transmitting sidelink signals/channels, but cancels/drops the transmissions on some slots and/or reselects resources for the sidelink signals/channels expected to be transmitted on these slots due to the failure of LBT, half-duplex, re-evaluation and/or pre-emption, the UE can adjust the transmission parameters of the sidelink signals/channels transmitted on the slots that will still be used accordingly, or cancel/drop/reselect resources for PSSCH and/or PSCCH resources according to the transmission parameters. The following provides a method for UE to adjust transmission parameters or determine cancel/drop/reselect resources for PSSCH and/or PSCCH.

In an exemplary embodiment, the UE selects multiple consecutive slots for transmitting PSSCH and/or PSCCH associated with PSSCH, and determines the transmission parameters of PSSCH and/or PSCCH transmitted on the slots that are still in use according to the number and/or position of the slots actually used for transmission, and/or the number and/or position of the slots on which the transmissions are canceled/dropped, and/or the number and/or position of PSSCH and/or PSCCH being cancelled/dropped/resources reselected. In other exemplary embodiments, PSSCH and/or PSCCH may also be other sidelink signals/channels, such as at least one of SL-PRS, S-SSB and PSFCH.

In another exemplary embodiment, the UE determines the PSSCH and/or PSCCH that need to be cancelled/dropped/resources reselected, including determining which of PSCCH and/or PSSCH to be cancelled according to transmission parameters of the PSSCH and/or PSCCH.

The transmission parameters of PSSCH and/or PSCCH in the above embodiments include at least one of: redundancy version, RV, modulation and coding mode, MCS, time resources allocation, frequency domain resources allocation, priority, NDI, HARQ enable/disable indication and CSI request. The above transmission parameters may be corresponding parameters indicated in SCI.

In a specific example, the UE selects slots 0-3 for transmitting four PSSCHs and their respective associated PSCCHs. In this example, four PSSCHs correspond to four retransmissions of one TB. Write four PSSCHs as {PSSCH1, PSSCH2, PSSCH3, PSSCH4}, and their respective RVs are {0, 2, 3, 1} in chronological order; NDIs are {toggled, not toggled, not toggled, not toggled} in chronological order, which indicates that the first of the four PSSCHs is transmitted for the initial transmission and the other three are retransmissions.

Optionally, according to RV and/or NDI, the UE preferentially cancels the PSSCH with NDI of not toggled; and/or preferentially cancels the PSSCH with RV of non-zero according to RV ranking, and/or preferentially cancels the PSSCH corresponding to the RV whose value is ranked lower in a specific order. For example, if the specific order is {0,2,3,1}, UE will cancel the PSSCH of RV1 first, then cancel the PSSCH of RV3, and so on.

If the UE successfully acquires the channel, including initializing the COT through Type 1 LBT and/or acquiring the COT shared by other UEs and passing the LBT check within the COT, the UE transmits {PSSCH1, PSSCH2, PSSCH3, PSSCH4} and their respective associated PSCCHs in turn on slots 0-3.

If the UE cancels the transmissions on slots 0 and 1 due to the failure of LBT, the UE transmits two PSSCHs on slots 2-3. According to RV and/or NDI, UE cancels the transmissions of PSSCH3 and PSSCH4, and transmits PSSCH1 and PSSCH2 in turn on slots 2-3.

Optionally, after canceling the PSSCHs, the UE determines the RV and/or NDI of the PSSCHs still being transmitted according to the transmission condition, including sets the NDI field of the earliest PSSCH corresponding to the TB as toggled if the retransmissions of the TB are to be transmitted after canceling the first transmission of the PSSCH corresponding to the TB. For example, UE expects to transmit PSSCH1~4 in turn on slots 0~3, and cancels the transmissions of PSCCH 1 and 2 due to the cancellation of transmissions on slots 0 and 1. Since PSSCH 1~4 correspond to multiple transmissions of the same TB, and the initial transmission of PSSCH0 is cancelled, the NDI field of PSSCH3 is set to toggled.

The main advantage of the above method is that the UE can drop/cancel/reselect resources based on the fact that preferentially transmit the PSSCHs of more importance (for example, the initial transmitted PSSCH) on the available resources, instead of complying with the original expected order of transmission, that is, the correspondence between PSSCHs and resources, thus ensuring the system performance.

In the sidelink communication system, the UE selects periodic resources for the transmissions in the current period and the transmissions in the next period, and will indicate the resources and periods as reservations in SCI. If part of the resources in the current period are unavailable (cannot be used for the UE's transmission) due to LBT and other reasons, the UE can still use the previously reserved resources in other subsequent periods, or reselect resources for other subsequent periods accordingly. A method for indicating resources reservation on unlicensed frequency bands is provided below.

The UE may indicate that at most three resources r1, r2 and r3 used in the current period within the length of no more than 32 slots as the resources for reservation and current transmission, and indicate that the period p to reserve resources r1+p, r2+p and r3+p in the next period, and the time domain positions are determined by the time domain positions of r1-r3 plus p, and the frequency domain positions are the same as that in the current period of r1-r3. If part of the resources reserved in this period are unavailable, the UE can adjust the method of indicating the resources in the next period accordingly.

In an exemplary embodiment, the UE transmits PSSCHs on slot t, and indicates time domain resources and frequency domain resources in the associated SCI, and may also indicate an offset in time domain and/or frequency domain. The resources positions actually reserved for the UE are the time domain positions indicated by the UE in the SCI plus the indicated offset respectively. If the positions of reserved resources are earlier than the slot t, it means that the UE indicates the previous transmission, or the positions of resources indicated by the UE are not used for PSSCH transmissions. If the period p is indicated by the UE, the resources positions reserved by the UE for the next period are the time-frequency resources positions of the UE indicated by the UE in the SCI plus the indicated offset and the resources positions after the period p respectively.

In another exemplary embodiment, the UE indicates the resources for current transmissions and future transmissions in the SCI through the time domain resources allocation domain and the frequency domain resources allocation domain, and indicates the previous resources through an additional field, the previous resources are used together with the domain indicating the period to make other UEs receiving the SCI determine the reserved resources of the UE for the next period.

The main advantage of the above method is that, since the criterion for UE to select resources is to avoid mutual interference in the sidelink system as much as possible instead of interference from LBT, even if the resources in the current period are unavailable for the sidelink transmissions due to the failure of LBT, the resources in the next period may still have better performance. Therefore, the UE can correctly indicate the resources for the next period when selecting resources through the above method, without triggering resources reselection or being limited by the transmission resources of the current period, and only reserve a subset of the selected resources for the next period, that is, only indicate the situation that only a subset of the resources reserved for the next period is actually reserved, which corresponds to the resources on which transmissions are actually transmitted in the current period.

When the UE communicates in unlicensed frequency bands, it performs LBT based on the contention window, and adjusts the contention window according to the state of the HARQ-ACK corresponding to the transmitted data channel, wherein the transmitted data channel can be a data channel within the sidelink reference time. The start position of the sidelink reference time may be the time when the COT is initialized by the UE or the shared COT is acquired, and the end position may be the slot on which the UE transmits at least one HARQ-ACK-enabled PSSCH, HARQ-ACK may be further defined as a HARQ-ACK mode including ACK and NACK. When the UE transmits a plurality PSSCHs and/or other sidelink signals/channels (such as PSFCH and S-SSB) within a COT, including MCSt-based transmissions, the end position of the sidelink reference time can be adjusted accordingly. The following provides a method for determining the end position of the sidelink reference time and a method for adjusting the contention window within the sidelink reference time based on the end position. Optionally, the UE uses this method at least when it selects multiple consecutive slots for sidelink transmission.

In an exemplary embodiment, the UE transmits sidelink signal/channels (e.g., PSSCH and/or associated PSCCH, PSFCH, S-SSB, SL-PRS) within one COT, and indicates a plurality of resources for transmitting the sidelink signal/channels in SCI, including indicates multiple consecutive and/or inconsecutive slots for transmitting the sidelink signal/channels. The end position of the sidelink reference time is determined based on the plurality of resources indicated in the SCI, including at least one of: the last slot of the multiple consecutive slots for transmitting the sidelink signal/channels indicated by the UE in the SCI; the slot on which the latest resource among the resources indicated by UE in the SCI is located.

Further, since UE usually indicates at most 3 resources in the SCI, but UE may need to occupy more than 3 slots in COT for sidelink transmission, the end position of the sidelink reference time can be determined not only based on one SCI, but also based on a plurality of SCIs. For example, the end position of the sidelink reference time is determined based on the resource with the latest reservation time among the plurality of SCIs transmitted by the UE. Wherein the the plurality of SCIs can be SCIs transmitted on the resources indicated by the first SCI (called SCI-X), or SCIs transmitted on the resources indicated by SCI-X (called SCI-Y), and so on until no more resources except the current transmissions are indicated in SCI, or until the COT ends. A specific example is that the UE indicates two resources in SCI-1, and transmits SCI-2 and SCI-3on these two resources respectively, SCI-2 indicates the resource of SCI-3 and another resource, and SCI-3 indicates the another resource indicated in SCI-2, and the UE transmits SCI-4 on the another resource, and no more resources are indicated, then the end position of the sidelink reference time is the slots on which the SCI-4 is located. Optionally, in this method, if the end position of the sidelink reference time determined based on SCI exceeds the end position of COT, it is determined that the end position of the sidelink reference time is the end position of COT.

In determining the sidelink reference time according to the above method, the UE may transmit a plurality of sidelink signals/channels, such as transmitting a plurality of PSSCHs. Accordingly, the UE determines how to adjust the contention window according to the HARQ-ACK states of the plurality of PSSCHs, including at least one of methods:
for at least one of a plurality of PSSCHs, if based on their HARQ-ACK feedbacks (including the case where feedbacks are not received and the case where HARQ-ACK is not enabled, the following is similar), the contention window CW (which can be CW of each priority or CAPC level, the following is similar) can be reset to the minimum value CW_{min,p}, the CW is reset to the minimum value CW_{min,p}; and/or if the number of PSSCHs whose HARQ-ACK feedbacks can reset the contention window CW to the minimum value CW_{min,p} satisfies a threshold range, or the percentage of the number among the PSSCHs satisfies the threshold range, or the number is more than that of PSSCHs corresponding to other methods for adjusting CW, the CW is reset to the minimum value CW_{min,p};
for at least one of the plurality of PSSCHs, if the contention window can be increased based on their HARQ-ACK feedbacks, including to be increased to the next allowable value, then the contention window is increased; and/or, if the number of PSSCHs whose HARQ-ACK feedbacks can increase the contention window satisfies a threshold range, or the percentage of the number among the PSSCHs satisfies a threshold range, or the number is more than that of PSSCHs corresponding to other methods for adjusting CW, the contention window is increased;
for at least one of the plurality of PSSCHs, if the contention window can be maintained at the current value based on its HARQ-ACK feedback, the contention window is maintained at the current value; and/or, if the contention window can be maintained at the current value based on its HARQ-ACK feedback, or the percentage of the its number in the plurality of PSSCHs satisfies a threshold range, or its number is more than that of PSSCHs corresponding to other methods for adjusting CW, the contention window is maintained at the current value;
for at least one of the plurality of PSSCHs, if the contention window can be set to a specific value based on its HARQ-ACK feedback, the contention window is set to a specific value; and/or, if the contention window can be set to a specific value based on its HARQ-ACK feedback, or the percentage of the its number in the plurality of PSSCH is within a threshold range, or its number is more than that of PSSCH corresponding to other methods for adjusting CW, the contention window is set to a specific value.

If the above-mentioned methods are adopted, the UE selects among the methods based on a predetermined order, for example, the UE preferentially determines whether the CW can be reset to the minimum value CW_{min,p},
then determines whether the contention window can be increased, and then determines whether the contention window can be maintained at the current value.

The advantage of this method is that when the UE transmits a plurality of sidelink signals/channels within one COT, the average state of a plurality of HARQ-ACK feedbacks can better reflect the interference degree of the channels than that of a single HARQ-ACK feedback, and if there are transmissions that use multicast HARQ-ACK feedbacks with only NACK and do not enable HARQ-ACK feedbacks in a plurality of sidelink signals/channels, due to the possible lacking of HARQ-ACK feedback information, it is difficult to guarantee the accuracy of HARQ-ACK transmissions based on the transmissions themselves, so the UE can take the adjustment of the contention window by other sidelink signals/channels as a reference.

In the sidelink communication system, the UE needs to acquire the channels by LBT before transmitting the sidelink transmissions. Therefore, when multiple sidelink UEs are within a communication range, there may be a situation where the LBTs are blocked mutually, and there may be a scene where one transmission of the UE makes other UEs' LBT fail and be forced to reselect resources. The following provides a method to reduce the risk of LBTs block mutually between UEs.

In an exemplary embodiment, the UE uses at least one of methods when selecting resources, wherein the reserved resources including resources reserved by other UEs can be determined by SCI indication:
method 1a: the UE avoids selecting N consecutive resources before (here, it can refer to before and after in terms of time) reserved resources with high priorities. Optionally, if the symbols used for transmissions on the selected resources overlap with the duration of LBT of the reserved resources, this method is performed;
method 1b: the UE avoids selecting N consecutive resources after(here, it can refer to before and after in terms of time) reserved resources with high priorities. Optionally, if the duration for transmitting the performed LBT on the selected resources overlaps with the symbols for the sidelink transmissions of the reserved resources, this method is performed;
method 2a: the UE selects or preferentially selects resources after(here, it can refer to before and after in terms of time) a reserved resource for transmission. Optionally, if the transmissions on the selected resources can share the COT of the reserved resource, and/or if the transmissions on the selected resources can obtain the shared/initialized COTs, this method is performed;
method 2b: the UE selects or preferentially selects the resources before (here, it can refer to before and after in terms of time) a reserved resource for transmission. Optionally, if the transmissions on the selected resources can share their initialized COTs with the reserved resource, and/or if the transmissions on the selected resources can obtain the shared/initialized COTs, this method is performed;
method 3: for one TB, the UE selects more resources than actually needed to mitigate the potential failure of LBT. Optionally, the number of selected resources is determined based on at least one of: a preset/preconfigured/high layer or base station configured number, the number may be preset/configured based on priority and/or CAPC level; channel congestion, including determining the number through CBR; the length of the contention window corresponding to the selected resources; the length of CPE corresponding to the selected resources;
method 4: determines the expected LBT duration first, and then takes the expected LBT duration into consideration when selecting resources.

Wherein the reserved resources with high priorities include resources with priorities higher than a threshold (the values of priorities are lower than the threshold), and the threshold can be preset/preconfigured/configured by high layer or base station and/or determined based on the CAPC level; and/or resources with priorities higher than priorities of the transmissions corresponding to the resources selected by the UE itself.

Wherein the CAPC levels and/or priorities of the reserved resources may be the CAPC levels and/or priorities indicated in the SCI that reserves the resources, or the CAPC levels of the COTs where the reserved resources are located. The CAPC levels and/or priorities of the selected resources may be the CAPC levels and/or priorities of the transmissions corresponding to the selected resources and may be indicated by the high layer.

Optionally, the method 1a and/or the method 1b is performed by the physical layer, including performed in a manner of excluding the resources avoided in the method 1a and/or the method 1b from the candidate resources set in the resource determination process. Further, in the resource determination process, the UE determines the duration of LBT and/or the value of N that the detected reserved resources may correspond to, and excludes the candidate resources overlapping with this positions; alternatively, this method can be used for method 1a. And/or, in the process of selecting resources, the UE determines the corresponding LBT duration and/or the value of N for the selected resources; alternatively, this method can be used for method 1b.

Optionally, after the resources exclusion in the method 1a and/or the method 1b is performed, the physical layer needs to determine whether the number and/or the proportion of the remaining resources in the candidate resources set satisfies a predetermined value range, and if not, at least one of the following is performed: increase the RSRP threshold in the resources exclusion process (including increase the RSRP threshold of reserved resources that satisfy the exclusion conditions in methods 1a and 1b in the resources exclusion process), reduce the value of N and/or the LBT duration of reserved resources, increase the length of RSW in the process of resources exclusion (for example, delay the end time of RSW and advance the start time of RSW without exceeding the remaining PDB) and/or the minimum number Yₘᵢₙ of slots included in the candidate resources set, and not use method 1a and/or method 1b.

Optionally, the method 1a and/or the method 1b is performed by high layer (e.g., the MAC layer), including performed in a manner of excluding the resources described in the methods 1a and 1b from the candidate resources set in the resource determination process. Further, the UE reports the duration of LBT and/or the value of N corresponding to the reserved resources to the high layer, including report the positions of the reserved resources to the high layer by the physical layer, and/or report the duration of LBT and/or the value of N corresponding to the reserved resources determined by the physical layer of the UE to the high layer by the physical layer, and/or report at least one of parameters to the high layer by the physical layer for the high layer to determine the duration of LBT and/or the value of N corresponding to the reserved resources: the time domain and/or frequency domain positions of the reserved resources, the priorities of the reserved resources, the CAPC levels of the reserved resources; based on the information reported by the physical layer, the high layer avoids selecting the above resources; alternatively, this method can be used for method 1a. And/or the physical layer of the UE reports the duration of LBT and/or the value of N corresponding to the selected resources to the high layer, including report the duration of LBT and/or the value of N corresponding to the selected resources determined by the physical layer of the UE to the high layer by the physical layer, and/or report at least one of parameters to the high layer for the high layer to determine the duration of LBT and/or the value of N corresponding to the selected resources: the length of the contention windows corresponding to the selected resources and the length of the CPEs corresponding to the selected resources. After the high layer determines the duration of LBT and/or the value of N of the reserved resources, it selects the resources that conform to the methods 1a and/or 1b from the candidate resources set. Alternatively, this method can be used for method 1b.

Optionally, after performing the exclusion, the high layer needs to determine whether the number and/or proportion of the remaining resources in the candidate resources set satisfies a predetermined range, and if not, at least one of the following is performed: reduce the value of N and/or the LBT duration of the reserved resources, trigger the physical layer to report the candidate resources set again (optionally, require the physical layer to report a new set and/or a set with more candidate resources), and not use method 1a and/or method 1b.

Optionally, the method for the physical layer and/or the high layer of the UE to determine the duration of LBT and/or the value of N corresponding to the reserved resources includes determining according to the CAPC levels and/or priorities corresponding to the reserved resources. Further, the duration of LBT and/or the value of N corresponding to the reserved resources can be the maximum LBT duration corresponding to CAPC level and/or the value of N corresponding to the maximum LBT duration; or the duration and/or the value of N of a specific LBT corresponding to the CAPC level, which can be preset/preconfigured/configured by high layer or base station, and the configuration can be based on the CAPC level. For example, the configuration of N obtained by the UE is preset/preconfigured/configured by high layer or base station, the CAPC levels {1, 2} and {3, 4} correspond to N=1 and N=2 respectively, and determines the value of N according to the CAPC levels corresponding to the reserved resources.

Optionally, the method that the physical layer and/or the high layer of the UE determines the duration of the corresponding LBT and/or the value of N for the selected resources includes determining based on the CAPC levels and/or priorities of the transmissions corresponding to the selected resources. Further, the duration of LBT and/or the value of N corresponding to the reserved resources can be the maximum LBT duration corresponding to CAPC level and/or the value of N corresponding to the maximum LBT duration; or the duration and/or the value of N of a specific LBT corresponding to the CAPC level, the duration and/or the value of N of the specific LBT can be preset/preconfigured/configured by high layer or base station, and the configuration can be based on the CAPC level, and its example is similar to that of reserved resources; or the duration of LBT and/or the value of N can be determined based on the value of contention window CW of LBT and/or the length of CPE.

Optionally, when at least one of the conditions below is met, the UE determines that the transmissions on the selected resources can share the COTs of the reserved resources, and/or the transmissions on the selected resources can obtain the shared/initialized COTs: the CAPC levels of the transmissions on the selected resources are higher than or equal to the CAPC levels of the reserved resources; the reserved resources indicates the information of sharing COTs in the SCI indicating the reserved resources; the selected resources are in the initialized or shared COTs (this condition can also be considered as the combination of method 4 and method 2a and/or method 2b); there are other selected resources in a specific time range before the selected resources, and the other selected resources can be used to initialize COTs including the selected resources (this condition can also be considered as the combination of method 4 and method 2a and/or method 2b).

Optionally, when the UE reserves resources, if the COTs initialized for the reserved resources are expected to be shared with other UEs, the information of sharing COTs is indicated in the SCI that reserves the resources. Optionally, the information includes the CAPC levels corresponding to the shared COTs, and/or the ID corresponding to the shared COTs, which may include the destination ID indicated in the SCI that reserves the resources, and/or the additional ID indicated in the SCI that reserves the resources.

Optionally, when at least one of the conditions below is met, the UE determines that the transmissions on the selected resources can share their initialized COTs with the reserved resources, and/or if the transmissions on the selected resources can obtain the shared/initialized COTs: the CAPC levels of the transmissions on the selected resources are lower than or equal to the CAPC levels of the reserved resources; the selected resources are in initialized or shared COTs, and the ID indicated in the sharing information of the COT includes the source ID of the UE corresponding to the reserved resources, and the CAPC levels corresponding to the reserved resources and the selected resources are higher than or equal to the CAPC levels of the initialized or shared COTs (this condition can also be considered as the combination of method 4 and method 2a and/or method 2b).

Optionally, the method 2a and/or the method 2b is performed by the physical layer, including performed in a manner of preferentially excluding resources that do not conform to the selection in the method 2a and/or the method 2b from the candidate resources set in the resource determination process, and/or performed in a manner of preferentially including resources selected in the method 2a and/or the method 2b in the candidate resources set reported to the high layer in the resource determination process. Optionally, after the selection/prioritized selection in the method 1a and/or the method 1b is performed, the physical layer needs to determine whether the number and/or the proportion of the selected/prioritized resources in the candidate resources set satisfy a predetermined value range, and if not, at least one of the following is performed: increase the RSRP threshold in the resources exclusion process (including increase the RSRP threshold in the resources exclusion process, the RSRP threshold of reserved resources that satisfy the conditions of being selected/preferentially selected in methods 2a and 2b), increase the length of RSW in the process of resources exclusion and/or the minimum number Yₘᵢₙ of slots included in the candidate resources set, include other candidate resources that do not satisfy the requirements of method 2a and/or method 2b (which may be the candidate resources determined according to the resource determination process in the licensed frequency bands) in the candidate resources set until the predetermined value range is met, and not use method 2a and/or method 2b.

Optionally, the method 2a and/or the method 2b is performed by a high layer (e.g., the MAC layer), including in a manner of preferentially selecting the resources described in the methods 2a and 2b from a set of candidate resources in the resource determination process. Further, the physical layer of the UE reports at least one of the following to the high layer for the high layer to perform the method 2a and/or the method 2b: the positions of the reserved resources, the CAPC levels of the reserved resources, the positions of the initialized COTs, the positions of the shared COTs, the positions of the resources that can be used to initialize the COTs, and the set of candidate resources that satisfies the requirements described in 2a and 2b. The high layer selects resources based on the information reported by the physical layer.

Optionally, after performing the selection, the high layer needs to determine whether the number and/or proportion of resources preferentially selected in the candidate resources set satisfies a predetermined range, and if not, performs at least one of: trigger the physical layer to report the candidate resources set again (optionally, require the physical layer to report a new set and/or a set with more candidate resources), and not use method 2a and/or method 2b.

Optionally, when the UE obtains its scheduled sidelink resources from the base station for transmission, that is, mode 1 is used, the UE reports at least one of information to the base station to enable the base station to achieve the effect of at least one of the above methods: the time domain and/or frequency domain positions of the reserved resources; CAPC levels and/or priorities of reserved resources; LBT duration of reserved resources and/or the corresponding value of N; the CAPC levels and/or priorities that UE needs to use for its own transmissions; the LBT duration and/or the corresponding value of N that UE needs to use for its own transmissions; the length of the contention windows corresponding to the selected resources; the length of CPE corresponding to the selected resources; information of COTs initialized and/or shared by UE; information about resources of the COTs that the UE expects to be initialized and/shared.

The method that the base station determines the LBT duration and/or the value of N based on the above information is similar to the method that the high layer determines the LBT duration and/or the value of N based on the information reported by the physical layer.

Optionally, the UE obtains at least one of the following information from the base station, and determines how to initialize the COTs based on the information: the UE should share the COTs with other UEs, possibly including the ID of the other UEs; parameters used by the UE to initialize COTs, including CAPC levels (which may be different from that of the sidelink transmissions of the UE), time-domain start positions and/or end positions and/or duration of COTs, and/or frequency-domain position information of COTs; the positions of resources that the COTs initialized by the UE should include, which may be the position of at least one reserved resources.

If the UE is configured/preset to support more than one method mentioned above, it can select the method to be used according to at least one of criteria:
selects the method to be used according to preset and/or configured priorities among different methods;
when the optional conditions in method 2a and/or method 2b are met, method 2a and/or method 2b is used; otherwise, method 1a and/or method 1b and/or other methods is used.

For example, if the UE determines that the transmissions on the selected resources can share the COTs of the reserved resources, and/or that the transmissions on the selected resources can obtain the shared/initialized COTs (the specific method for determining whether the conditions are met is shown above), the UE uses method 2a; otherwise, if it is determined that the transmissions on the selected resources can share their initialized COTs with the reserved resources, the UE uses method 2b; otherwise, the UE uses method 1a and/or method 1b.

For another example, if the UE determines that the transmissions on the selected resources can share their initialized COTs with the reserved resources, the UE uses method 2b; otherwise, if it is determined that the transmissions on the selected resources can share the COTs of the reserved resources, and/or the transmissions on the selected resources can obtain the shared/initialized COTs (the specific method for determining whether the condition are met is shown above), the UE uses method 2a; otherwise, the UE uses method 1a and/or method 1b.

For another example, if the UE detects reserved resources with high priorities, if the UE can select the resources before the reserved resources as the candidate resources (for example, in the resource determination process, the resources are reserved in the candidate resources set), and/or the UE can share the COTs where the resources before the reserved resources are located to the reserved resources or to other UEs that reserve the resources the COTs are initialized by the UE, and/or the CAPC levels of the transmissions corresponding to the resources selected by the UE are lower than or equal to the CAPC levels of the transmissions corresponding to the reserved resources (this condition can be understood as a further detailed description of the above-mentioned condition that the UE can share the COTs of the resources before the reserved resources to the reserved resources or to other UEs that reserve the resources), the UE uses method 2b and/or method 2a; otherwise, the UE uses method 1b and/or method 1a.

1. A method performed by a first node in a communication system, the method comprising:
determining resources for transmitting sidelink transmissions; and
transmitting the sidelink transmissions on the determined resources, wherein at least one of the followings is satisfied:
in case that the determined resources include multiple consecutive time units and N time units of the multiple consecutive time units unavailable for the sidelink transmissions, at least one of the sidelink transmissions is transmitted on at least one of time units available for the sidelink transmissions of the multiple consecutive time units, or time units other than the multiple consecutive time units and consecutive with the time units available for the sidelink transmissions of the multiple consecutive time units, wherein N is an integer greater than or equal to 1;
the determined resources are determined among resources whose number is greater than the number of resources required for the sidelink transmissions; or
the determined resources are the candidate resources satisfying a first condition in a first candidate resources set, wherein the first condition includes that the candidate resources include multiple consecutive time units and each time unit does not include physical sidelink feedback channel (PSFCH) resource.

2. The method of claim 1, further comprising:
transmitting an indication that the sidelink transmissions are on resources including multiple consecutive time units.

3. The method of claim 1, wherein in the case that N time units of the multiple consecutive time units are unavailable for the sidelink transmissions, transmitting the sidelink transmissions on the determined resources comprises at least one of:
adjusting priorities of the sidelink transmissions, and transmitting at least one of the sidelink transmissions based on the adjusted priorities;
delaying time units occupied by the sidelink transmissions, and transmitting at least one of the sidelink transmissions based on the time units available for the sidelink transmissions or the delayed time unit of the multiple consecutive time units;
determining at least one of: at least one of the sidelink transmissions being dropped or at least one of the sidelink transmissions is transmitted; or
reselecting resources for at least one of the sidelink transmissions.

4. The method of claim 3, wherein adjusting the priorities of the sidelink transmissions comprises at least one of:
setting the priority of at least one of the sidelink transmissions as the priority configured by the high layer plus an offset, wherein the offset is configured or preset;
setting the priority of at least one of the sidelink transmissions as the highest priority of the sidelink transmissions;
adjusting the priorities of the sidelink transmissions on each time unit of the multiple consecutive time units; or
adjusting at least one of: the priorities of the sidelink transmissions on the delayed time units, or the priorities of the sidelink transmissions on the time units available for the sidelink transmissions of the multiple consecutive time units.

5. The method of claim 3, wherein N time units of the multiple consecutive time units are unavailable for the sidelink transmissions, including at least one of:
the first node fails to occupy a channel on the first N time units or any N time units of the multiple consecutive time units; or
the first N time units or any N time units of the multiple consecutive time units are reserved by other nodes.

6. The method of claim 3, wherein delaying the time units occupied by the sidelink transmissions comprises:
in case that there are resources available for at least one of the sidelink transmissions on the delayed N time units, and in case that the delayed N time units and the time units available for the sidelink transmissions are consecutive in the time domain, delaying the time units occupied by the sidelink transmissions.

7. The method of claim 6, further comprising at least one of:
transmitting one or more sidelink transmissions with larger remaining packet delay budgets (PDBs) among the sidelink transmissions; or
transmitting one or more sidelink transmissions with later time point corresponding to the remaining PDB among the sidelink transmissions on the delayed N time units.

8. The method of claim 6, further comprising at least one of:
transmitting one or more sidelink transmissions with low priorities among the sidelink transmissions on the delayed N time units; or
transmitting one or more sidelink transmissions with high priorities among the sidelink transmissions on non-delayed time units.

9. The method of claim 3, wherein determining at least one of: at least one of the sidelink transmissions is dropped or at least one of the sidelink transmissions is transmitted comprises at least one of:
in case that at least one of: (i) the resources corresponding to a first sidelink transmission among the sidelink transmissions are unavailable for the sidelink transmissions, the first sidelink transmission is dropped, or (ii) the resources corresponding to a second sidelink transmission among the sidelink transmissions are available for the sidelink transmissions, the second sidelink transmission is transmitted;
in case that at least one of: (i) resources available for the sidelink transmissions among the determined resources cannot carry a third sidelink transmission, the third sidelink transmission is dropped, or (ii) resources available for the sidelink transmissions among the determined resources can carry a fourth sidelink transmission, the fourth sidelink transmission is transmitted;
determining at least one of dropped sidelink transmissions or transmitted sidelink transmissions among the sidelink transmissions according to a latency requirement;
determining that one or more sidelink transmissions with low priorities among the sidelink transmissions are dropped, and determining that one or more sidelink transmissions with high priorities among the sidelink transmissions are transmitted; or
determining at least one of dropped sidelink transmissions or transmitted sidelink transmissions among the sidelink transmissions according to the hybrid automatic repeat request (HARQ) states of the sidelink transmissions,
wherein determining at least one of dropped sidelink transmissions or transmitted sidelink transmissions among the sidelink transmissions according to the hybrid automatic repeat request (HARQ) state of the sidelink transmissions comprises at least one of:
determining that at least one of the retransmissions or the transmissions without HARQ enabled among the sidelink transmissions are dropped; or
determining that an initial transmission among the sidelink transmissions is transmitted.

10. The method of claim 1, wherein determining resources for transmitting the sidelink transmissions comprises:
determining resources for transmitting the sidelink transmissions based on at least one of: (i) whether the first node occupies a signal in resources whose number is greater than the number of resources required for the sidelink transmission, or (ii) whether resources whose number is greater than the number of resources required for the sidelink transmissions are reserved by other nodes.

11. A method performed by a second node in a communication system, the method comprising:
receiving sidelink transmissions from a first node; and
determining that the sidelink transmissions are on resources including multiple consecutive time units.

12. The method of claim 11, wherein determining that the sidelink transmissions are on resources including multiple consecutive time units comprises:
receiving a first indication transmitted by the first node, the first indication indicates that the sidelink transmissions are on resources including multiple consecutive time units.

13. The method of claim 11, further comprising:
receiving a second indication for the priorities of the sidelink transmissions; and
determining the priorities of the sidelink transmissions based on the first indication and the second indication.

14. A node device comprising:
a transceiver; and
a processor coupled to the transceiver and configured to:
determine resources for transmitting sidelink transmissions; and
transmit the sidelink transmissions on the determined resources, wherein at least one of the followings is satisfied:
in case that the determined resources include multiple consecutive time units and N time units of the multiple consecutive time units unavailable for the sidelink transmissions, at least one of the sidelink transmissions is transmitted on at least one of time units available for the sidelink transmissions of the multiple consecutive time units, or time units other than the multiple consecutive time units and consecutive with the time units available for the sidelink transmissions of the multiple consecutive time units, wherein N is an integer greater than or equal to 1;
the determined resources are determined among resources whose number is greater than the number of resources required for the sidelink transmissions; or
the determined resources are the candidate resources satisfying a first condition in a first candidate resources set, wherein the first condition includes that the candidate resources include multiple consecutive time units and each time unit does not include physical sidelink feedback channel (PSFCH) resource.

15. A node device comprising:
a transceiver; and
a processor coupled to the transceiver and configured to:
receive sidelink transmissions from a first node; and
determine that the sidelink transmissions are on resources including multiple consecutive time units.
